(19) United States
(12) Patent Application Publication
(10) Pub. No.: US 2018/0116383 A1
(43) Pub. Date: May 3, 2018

(54) PHONE HOLDER SYSTEMS

(71) Applicant: Howard McGahey, Urbandale, IA (US)

(72) Inventor: Howard McGahey, Urbandale, IA (US)

(21) Appl. No.: 15/800,152

(22) Filed: Nov. 1, 2017

Related U.S. Application Data
(60) Provisional application No. 62/415,510, filed on Nov. 1, 2016.

(51) Int. Cl. A45F 5/00; H04M 1/05

(52) U.S. Cl. CPC A45F 5/00; H04M 1/05

(57) ABSTRACT

A phone holder system allows a user to stream from a mobile device hands free such that the appropriate field of view is achieved. Two pads are provided at specific contact points to avoid unnecessary pressure while wearing the phone holder system. The bar contours to the body and maintains balance, while the telescoping bar helps achieve the correct angle for filming without including unnecessary background/foreground images. The phone holder system folds so that it can be stored when not in use in a pocket or bag.

### CROSS REFERENCE TO RELATED PATENT APPLICTIONS

This application claims priority to U.S. Provisional Patent Application Ser. No. 62/415,510 filed on Nov. 1, 2016

### BACKGROUND OF THE INVENTION

### 1. Field of the Disclosure

The disclosure relates generally to the field of mobile device accessories and more specifically relates to a mobile device support apparatus.

### 2. Description of the Related Art

Many people today use mobile devices, typically in the form of a smart phone. A mobile device is a small computing device, typically small enough to be handheld, having a touch display screen which enables the user to use a virtual keyboard that is displayed on screen, along with other icons and buttons that can be pressed through the use of a graphical user interface.

Most if not all mobile devices have an operating system enabling them to run mobile applications, facilitate internet communications, and are also equipped with Wi-Fi, Bluetooth®, near field communication (NFC) capabilities and Global Positioning System (GPS) capabilities. Further, these devices can be used to take digital photographs and record, play and transmit digital video and/or audio.

Most mobile devices are capable of posting videos and images to online social media accounts via a wireless internet connection. Capabilities can also include live action video streaming, such as Skype® and FaceTime®, which connects two or more people in conjunction with the mobile device camera and microphone in real time.

In practice, it can be difficult for a user who is live streaming to hold the mobile device in the proper position in order to use these features. In addition, when holding a mobile device, the user loses the ability to use both hands for other operations. Furthermore, holding a mobile device in a user's hand has a tendency to cause the video to be of poor quality. A suitable solution is therefore desired.

Various attempts have been made to solve problems found in the mobile device accessory art. Among these are found in: U.S. Patent and Publication Nos. 2007/0164987 to Christopher Graham; U.S. Pat. No. 9,103,491 to Ka Chun Mak; and 2015/0305479 to Ricardo Sanchez. This prior art is representative of a mobile device support apparatus.

None of the above inventions and patents, taken either singly or in combination, is seen to describe the invention as claimed. Thus, a need exists for a reliable phone holder system, and to avoid the above-mentioned problems.

### BRIEF SUMMARY OF THE INVENTION

The disclosure advantageously fills the aforementioned deficiencies by providing a lightweight mobile device support apparatus. The disclosed device and method of use is superior to other systems in that it effectively maintains the mobile device at an appropriate position, angle and distance from the user in a hands free manner.

The phone holder system has a main bar, a neck pad, a chest pad, a telescoping bar and hinges. The main bar contours to the general form of the human body, and provides the main source of balance for the phone holder system. The neck pad may comprise a soft material that provides cushion around the neck area when worn. The chest pad may also comprise a soft material, and rests just below the chest area, so that the bar is not in contact with the human body thereby providing increased comfort. The phone holder system may also include a plurality of hinges so that the system may be adjustable as well as convert between a deployed position and a folded position so that it can be stored when not in use, in a pocket or purse. The telescoping bar which connects to the mobile device may be telescoping so that the user may adjust the height which suits them best. The mobile device may also be connected to a hinge that facilitates lateral tilting, vertical tilting as well as rotation of the mobile device.

The phone holder system may allow a user to live stream, talk on Skype® and FaceTime®, and do many other tasks hands free. The phone holder system may be used quickly and stored easily. The device contours to the body for comfort so that weight is distributed evenly and maintains balance throughout the system while in use. The phone holder system has two comfort pads which prevent pressure from the two main points of contact, thereby alleviating any potential discomfort to the user.

The features of the disclosure which are believed to be novel are particularly pointed out in the specification. The disclosure now will be described more fully hereinafter with reference to the accompanying drawings, which are intended to be read in conjunction with both this summary, the detailed description and any preferred and/or particular embodiments specifically discussed or otherwise disclosed. This disclosure may, however, be embodied in many different forms and should not be construed as limited to the embodiments set forth herein; rather, these embodiments are provided by way of illustration only and so that this disclosure will be thorough, complete and will fully convey the full scope of the disclosure to those skilled in the art.

### BRIEF DESCRIPTION OF THE DRAWINGS

The figures which accompany the written portion of this specification illustrate embodiments and method(s) of use for the disclosed phone holder systems, constructed and operative according to the teachings presented herein.

FIG. 1 is a perspective view of a mobile device holder system; the view showing the mobile device holder system in a fully deployed position; the view showing the mobile device holder system formed of a main bar having a keeper section, a neck section an upper torso section, a lower torso section, a lower section and an extension section all of which are separated by a collapsible hinge; the view showing a telescoping section formed of a plurality of telescoping members connected to the outward end of the extension section; the view showing a universal joint having a socket, a ball and a plate connected to the end of the extension section 30; the view showing the mobile device holder system forming an opening at its middle that is configured to receive the head of a user; the view showing the mobile device holder system having a neck pad connected to the neck section and a chest pad connected to the lower section;

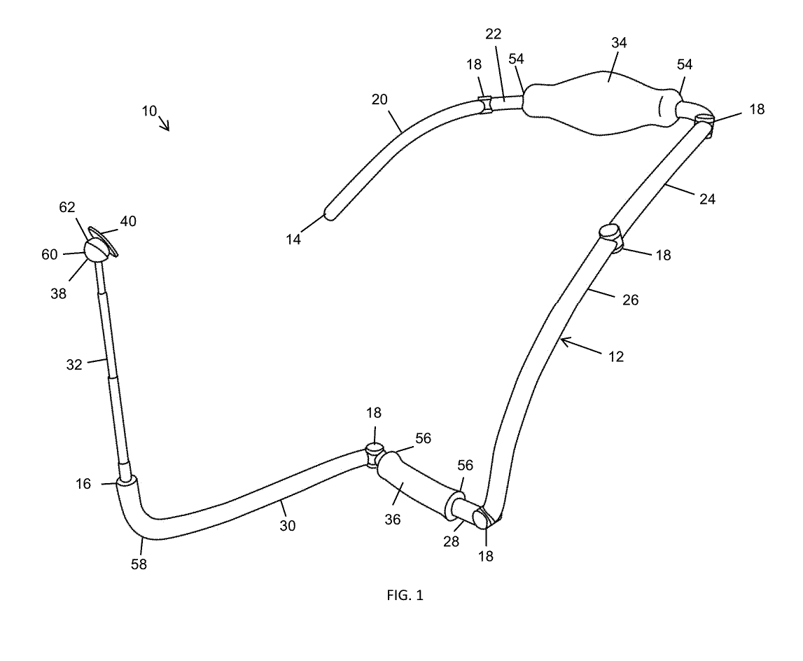

FIG. 2 is another perspective view of the mobile device holder system shown in FIG. 1;

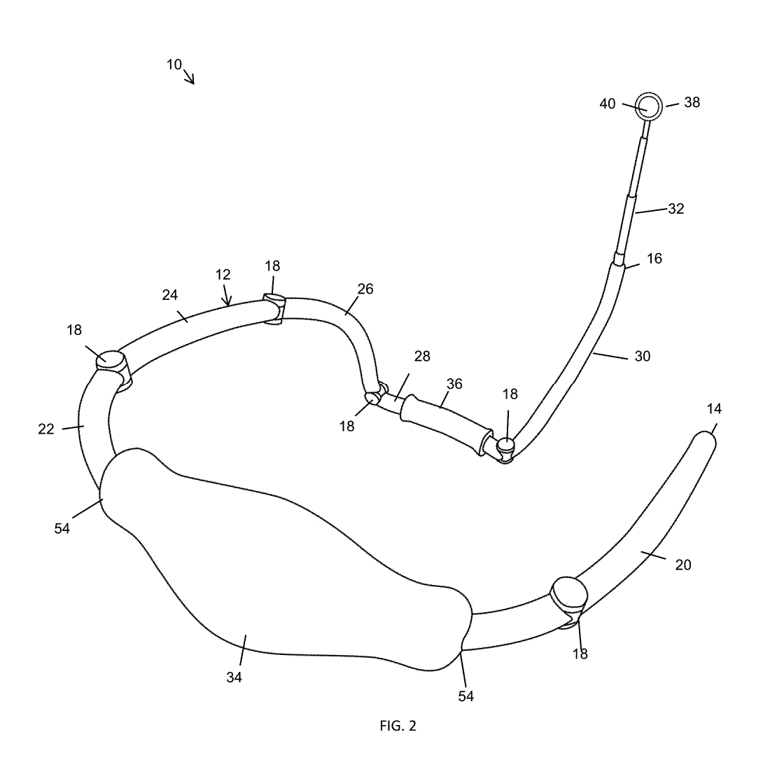

FIG. 3 is another perspective view of the mobile device holder system shown in FIG. 1;

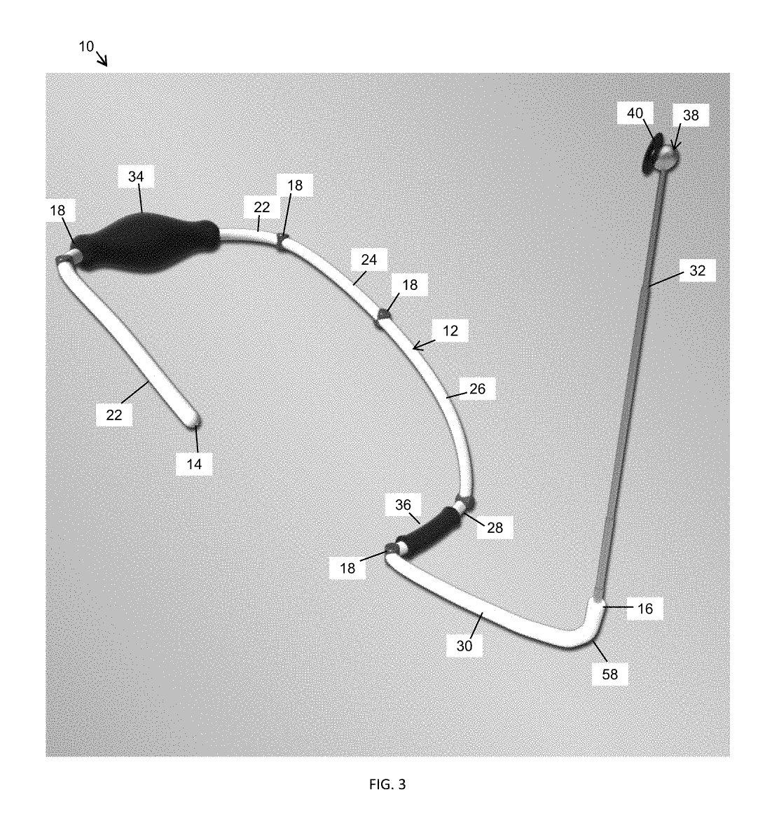

FIG. 4 is another perspective view of the mobile device holder system shown in FIG. 1;

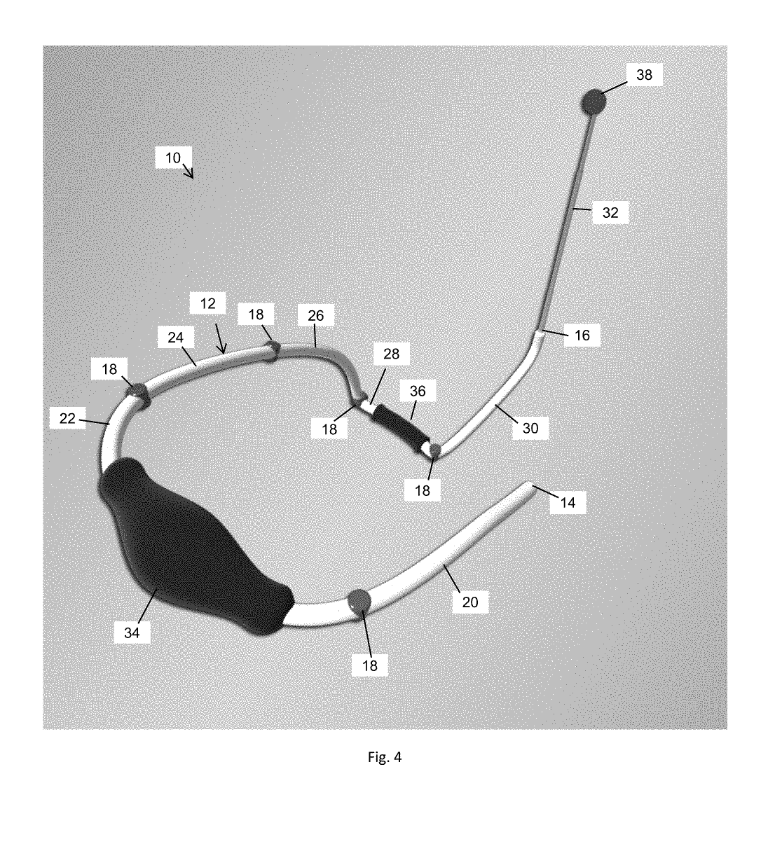

FIG. 5 is another perspective view of the mobile device holder system shown in FIG. 1; the view showing the telescoping section in a collapsed state;

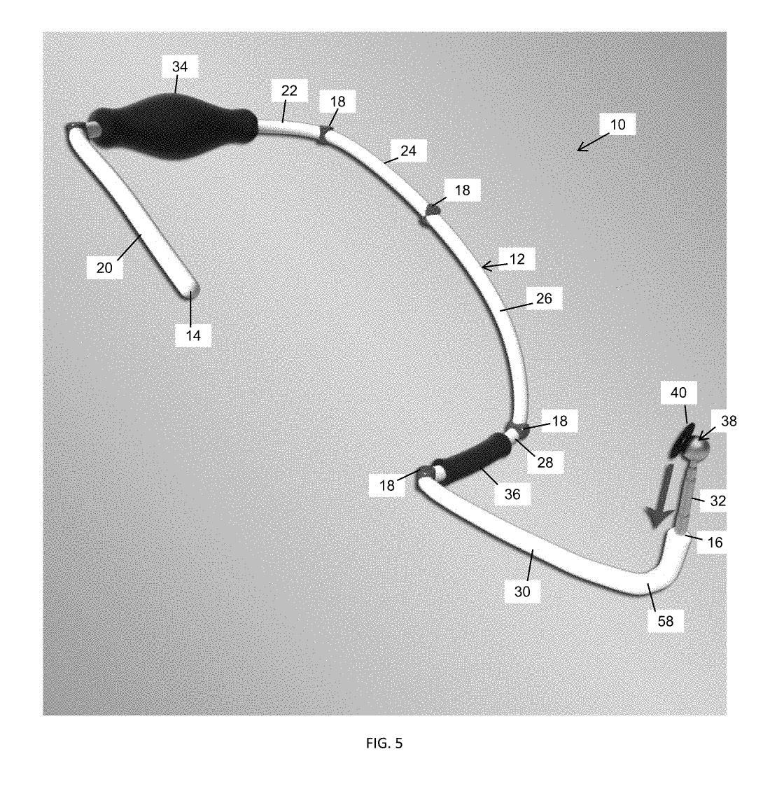

FIG. 6 is a perspective view of the upper end of the telescoping section; the view showing a universal joint connived to the upper end of the telescoping section; the view showing the telescoping member formed of a socket that receives a roller ball therein and a plate connected to the roller ball; the view showing a mobile device, a plate and a cover in exploded form about to magnetically connect to the universal joint;

FIG. 7 is a perspective view of the mobile device holder system shown in FIG. 1; the view showing the mobile device holder system positioned around a user's head; the view showing the telescoping section in a collapsed state;

FIG. 8 is a perspective view of the mobile device holder system shown in FIG. 1; the view showing the mobile device holder system positioned around a user's head; the view showing the telescoping section in an extended state;

FIG. 9 is a perspective view of the mobile device holder system shown in FIG. 1; the view showing the mobile device holder system positioned around a user's head; the view showing the telescoping section in an extended state; the view showing the mobile device rotated upon the universal joint;

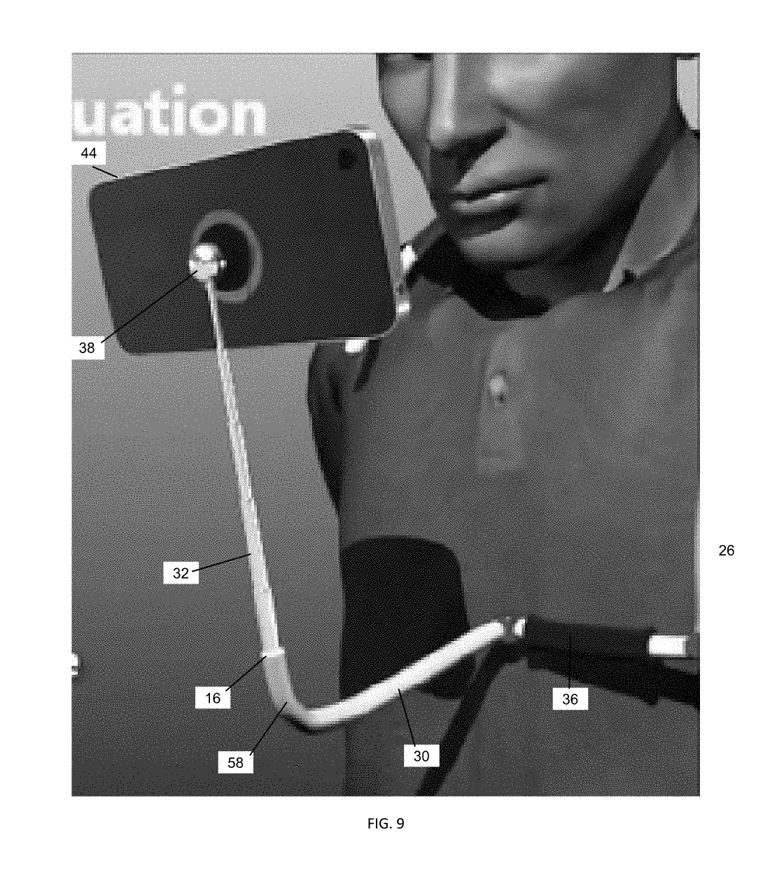

FIG. 10 is an exploded perspective view of the mobile device holder system shown in FIG. 1; the view showing a mobile device and a plate in an exploded manner prior to installation of the plate on the mobile device followed by installation of the adjoined mobile device and plate onto the universal joint;

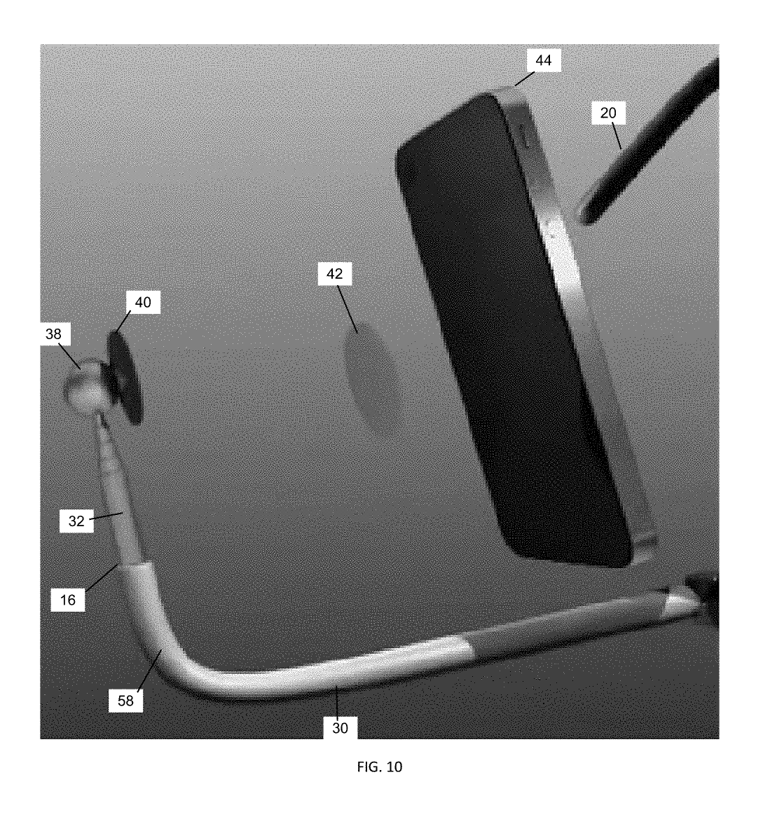

FIG. 11 is a perspective view of the arrangement shown in FIG. 10, the view showing the mobile device and adjoined plate installed onto the universal joint;

FIG. 12 is a close up perspective view of a hinge of the mobile device holder system; the view showing the hinge in a deployed position;

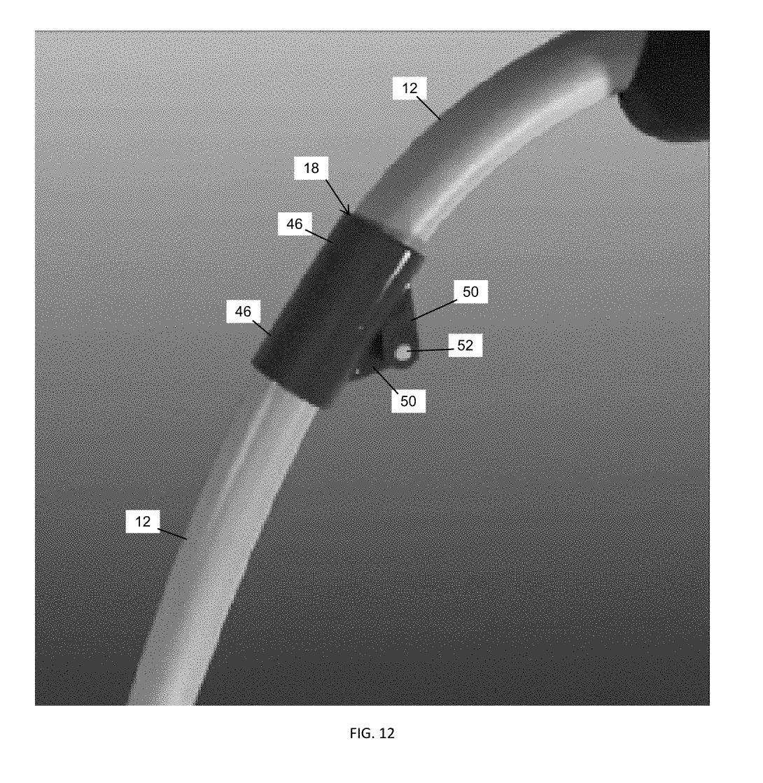

FIG. 13 is a close up perspective view of a hinge of the mobile device holder system; the view showing the hinge in a folded position; the view showing the magnetic member held within the hinge members of the hinge;

FIG. 14 is a perspective view of a mobile device holder system in a fully deployed position;

FIG. 15 is a perspective view of a mobile device holder system the view showing the mobile device holder system having the hinge 18 between neck section 22 and upper torso section 24 folded;

FIG. 16 is a perspective view of a mobile device holder system the view showing the mobile device holder system having the hinge 18 between neck section 22 and upper torso section 24 folded; the view also showing the hinge 18 between neck section 22 and keeper section 20 in a folded position;

FIG. 17 is a perspective view of a mobile device holder system the view showing the mobile device holder system having the hinge 18 between neck section 22 and upper torso section 24 folded; the view also showing the hinge 18 between neck section 22 and keeper section 20 in a folded position; the view also showing the hinge 18 between upper torso section 26 and the lower torso section 26 in a folded position;

FIG. 18 is a perspective view of a mobile device holder system the view showing the mobile device holder system having the hinge 18 between neck section 22 and upper torso section 24 folded; the view also showing the hinge 18 between neck section 22 and keeper section 20 in a folded position; the view also showing the hinge 18 between upper torso section 26 and the lower torso section 26; the view also showing the hinge 18 between lower torso section 26 and the lower section 28 in a folded position;

FIG. 19 is a perspective view of a mobile device holder system the view showing the mobile device holder system having the hinge 18 between neck section 22 and upper torso section 24 folded; the view also showing the hinge 18 between neck section 22 and keeper section 20 in a folded position; the view also showing the hinge 18 between upper torso section 26 and the lower torso section 26; the view also showing the hinge 18 between lower torso section 26 and the lower section 28 in a folded position; the view also showing hinge 18 between the lower section 28 and the extension section 30 in a folded position;

FIG. 20 is a perspective view of an exemplary use of the mobile device holder system in use around a user's head and attached to the user's body;

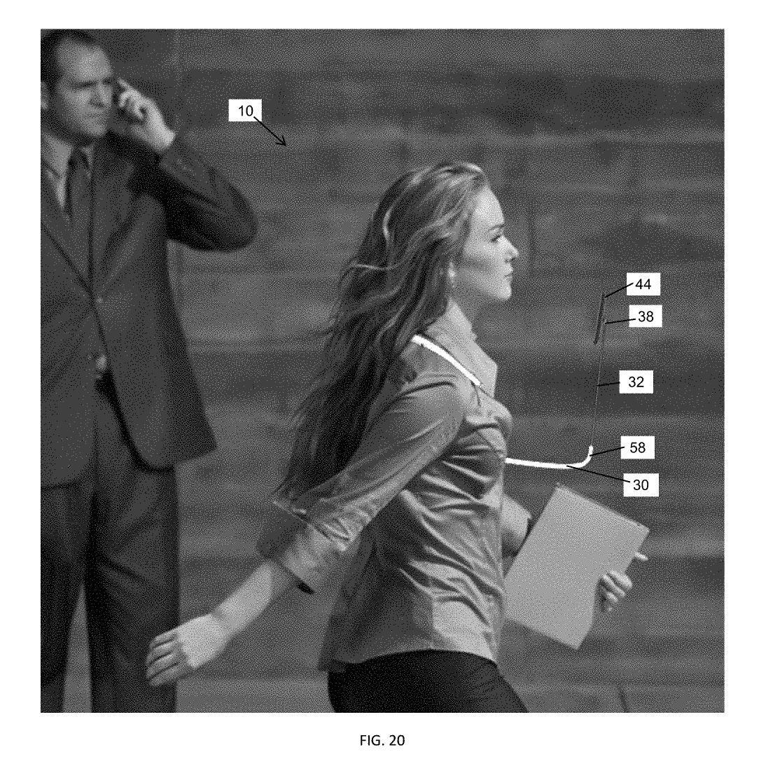

FIG. 21 is a perspective view of an exemplary use of the mobile device holder system in use around a user's head and attached to the user's body.

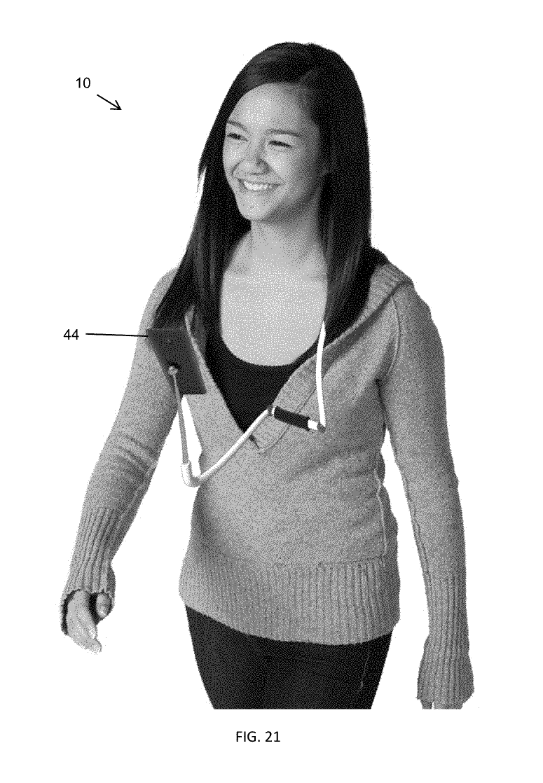

The various embodiments of the disclosure will hereinafter be described in conjunction with the appended drawings, wherein like designations denote like elements.

### DETAILED DESCRIPTION

With reference to the figures, a mobile device holder system 10, or simply system 10, is presented. Mobile device holder system 10 is formed of any suitable size, shape and design and is configured to hold a mobile device and attach it to a user's body for hands free use. In the arrangement shown, as one example, mobile device holder system 10 is formed of a main bar 12 that extends in a generally continuous manner from a first end 14 to a second end 16.

In one arrangement, as is shown, main bar 12 includes a plurality of hinges 18 that separate the main bar 12 into a plurality of sections. The presence of hinges 18 facilitate the transition of the system 10 between a deployed position, wherein the mobile device holder system 10 is fully extended and is ready to be worn by a user, and a folded position, wherein the mobile device holder system 10 is in a fully collapsed state for storage purposes.

In the arrangement shown, as one example, mobile device holder system 10 is separated into a keeper section 20, a neck section 22, an upper torso section 24, a lower torso section 26, a lower section 28, an extension section 30 and a telescoping section 32, among other components, as are further described herein. In the arrangement shown, a neck pad 34 is connected to the neck section 22 and a chest pad 36 is connected to the lower section 28. Also, a universal joint 38 is connected to the upward end of the telescoping section that includes a plate 40 that magnetically receives a plate 42 connected to a mobile device 44.

Main Bar:

Main bar 12 is formed of any suitable size, shape and design and serves as the main structural element of the mobile device holder system 10 that provides structural rigidity to the system 10. In the arrangement shown, as one example, main bar section 12 is a generally elongated cylindrical member that extends from first end 14 to second end 16 in a generally continuous manner, interrupted only by hinges 18 which separate main bar 12 into a plurality of sections, including a keeper section 20, a neck section 22, an upper torso section 24, a lower torso section 26, a lower section 28, an extension section 30 and a telescoping section 32.

Main bar 12, and the sections it forms, may be a generally rigid member from end 14 to end 16. That is, in this arrangement, main bar 12 is formed of a generally solid and rigid material that maintains its size and shape, such as a rigid plastic material or rubber material or composite material or metallic material. This arrangement provides the benefit of strength and rigidity. This arrangement also provides the benefit of the main bar 12 always being the same shape as it is formed of a rigid material.

In an alternative arrangement, main bar 12, and the sections it forms, are formed of a material that is partially flexible and/or malleable, such as a flexible or malleable plastic material or rubber material or composite material that allows for some deformation of the shape of main bar 12. This arrangement provides the benefit that the user can bend, twist, curve, stretch or otherwise adjust the shape of main bar 12 to fit their specific body and their specific uses which provides improved comfort and improved performance and functionality. The material properties of this partially flexible and/or malleable main bar 12 are a balance of providing flexibility and malleability while providing enough structural rigidity to sufficiently support mobile device 44 and to not collapse under normal use conditions.

In another arrangement, portions of main bar 12 are formed of a rigid material whereas other portions of main bar 12 are formed of a flexible and/or malleable material. This arrangement combines the benefits of both arrangements provided above. That is, rigid portions are provided where needed and soft, flexible, malleable or adjustable portions are provided where needed.

In the arrangement shown, main bar 12 includes a plurality of hinges 18 that interrupt the otherwise uninterrupted extension of main bar 12 from end 14 to end 16.

Hinges:

Hinges 18 are formed of any suitable size, shape and design and serve to connect adjacent sections of main bar 12 while facilitating the transition of the system 10 between a deployed position, wherein the mobile device holder system 10 is fully extended and is ready to be worn by a user, and a folded position, wherein the mobile device holder system 10 is in a fully collapsed state for storage purposes.

In the arrangement shown, as one example, hinges 18 are formed of a pair of generally cylindrical hinge members 46 that connect to opposing sections of main bar 12. In one arrangement, the generally cylindrical hinge members 46 include a generally cylindrical opening at their middle on opposing ends that receive an end of main bar 12 therein. Main bar 12 is then affixed or attached to hinge member 46 by any manner, method or means, such as by friction fit, gluing, welding, adhering, screwing, crimping, pinning, or any other manner, method or means.

In one arrangement, hinge members 46 include a magnetic member 48 therein. The presence of magnetic member 48 helps to hold the two opposing hinge members 46 together when mobile device holder system 10 is in a fully deployed position. In one arrangement, magnetic member 48 is a magnet placed in each of the hinge members 46 that attract to one another and hold the hinge 18 in a fully deployed position with the opposing hinge members 46 in engagement with one another. In another arrangement, magnetic member 48 includes a magnet placed in one of the opposing hinge members 46 and a metallic member placed in the other of the hinge members 46 such that the two hinge members 46 magnetically attract to one another and the hinge 18 is held in a deployed position.

In one arrangement, as is shown, hinge members 46 include arms 50 that extend outward from the cylindrical main body of hinge members 46 and connect to a pin 52. Pin 52 serves as both the connection point for opposing hinge members 46 as well as the axis of rotation for the opposing hinge members 46 when hinge members 46 transition from a deployed position to a folded position.IN the arrangement shown, hinges 18 allow main body 12 to extend in a straight manner in a deployed position and hinges 18 allow main body 12 to fold such that two sections of main body 12 may lay flat on one another in overlapping condition.

Any other form of a hinge-type device is hereby contemplated for use in place of the manner of a hinge 18 described herein. In one arrangement, it is contemplated that sections of main bar 12 may be so flexible that they facilitate folding of the mobile device holder system 10 without the presence of hinge 18.

As one example of an alternative hinge member, instead of using a magnetic member 48 to maintain the hinge 18 in an open position, a friction fit member may be used, such as two frictionally engaging and frictionally locking members. In another arrangement, an engagement member may be used on opposing hinge members 46 such as a soft touch fastener, or hook and loop fastener (also known as Velcro®), a hard touch fastener, such as flexible but rigid inter-engaging mushroom shaped members, or any other connection member. Also, threaded fastening members and locking fasting members are also contemplated for use, as is any other fastening member or method.

Keeper Section:

Keeper section 20 is formed of any suitable size, shape and design and serves as a structural support element that is positioned on one side of the user's head opposite the upper torso section 24 and lower torso section 26 which are positioned on the other side of the user's head. In the arrangement shown, as one example, keeper section 20 begins at its lower end at first end 14 extends upward a length before terminating at hinge 18 which is positioned between the upward end of keeper section 20 and neck section 22. In one arrangement, as is shown, when viewed from the side, keeper section 20 curves downward as it extends outward so as to follow the contour of the user's body and smoothly transition from the user's neck area to across a portion of their shoulder and/or chest.

The presence of keeper section 20 provides stability to mobile device holder system 10 and prevents the mobile device holder system 10 from sliding off of the user's body as the keeper section 20 is positioned on one side of the user's head and the upper torso section 24 and lower torso section 26 are positioned on the other side of the user's head.

In one arrangement, as is shown, keeper section 20 extends in a generally vertical manner from its lower end at first end 14 to its upper end at hinge 18. In one arrangement, keeper section 20 is formed of a rigid member. In another arrangement, keeper section 20 is a flexible or malleable member so that the shape of keeper section 20 may be conformed to the size and shape of the user's body. In another arrangement, keeper section 20 includes portions that are rigid and other sections that are flexible or malleable which provides the benefits of being rigid where it is needed and flexible or malleable where adjustment may be required thereby providing the benefits of both.

Neck Section:

Neck section 22 is formed of any suitable size, shape and design and serves as a structural support element that is positioned behind the user's head opposite and extends across the back of the user's neck. In the arrangement shown, as one example, neck section 220 begins at one end at hinge 18 which is positioned between the upward end of keeper section 20 and neck section 22 and terminates at an opposite end at a hinge 18 which is positioned between the neck section 22 and the upper torso section 24. In one arrangement, as is shown, neck section 22 extends in a relatively straight or curved member between these hinges 18. In one arrangement, neck section 22 is formed of or includes a relatively concave shape that receives a user's neck at approximately the apex of the curve such that the neck section 22 is relatively self-centering on the user's neck.

The presence of neck section 22 and its engagement with the user's neck provides stability to mobile device holder system 10 as the mobile device holder system 10 essentially hangs from the user's neck by neck section 22 which prevents the mobile device holder system 10 from sliding down the user's body. As the weight of the mobile device holder system 10 is essentially hanging from the neck section 22, in one arrangement a neck pad 34 is placed over the neck section 22 so as to spread out the contact area between the user's neck and the neck section 22 and to provide some cushion to this engagement thereby improving user comfort.

In one arrangement, neck section 22 is formed of a rigid member. In another arrangement, neck section 22 is a flexible or malleable member so that the shape of neck section 22 may be conformed to the size and shape of the user's body. In another arrangement, neck section 22 includes portions that are rigid and other portions that are flexible or malleable which provides the benefits of being rigid where it is needed and flexible or malleable where adjustment may be required thereby providing the benefits of both.

Neck Pad:

Neck pad 34 is formed of any suitable size, shape and design and serves to engage the user's neck and to spread out the contact area between the user's neck and the neck section 22 thereby improving user comfort. In the arrangement shown, neck pad 34 is generally centrally positioned upon neck section 22 and curves in accordance with the curvature of neck section 22. In the arrangement shown, as one example, neck pad 34 extends a lateral length between opposing ends 54 and widens at its middle as compared to its ends. When viewed from the side, the center section or wider section at its middle has generally flat opposing faces that engage the user's neck or shoulder area. This curvature and generally flat surface shape facilitates comfortable engagement of the user's neck and/or shoulder area.

Neck pad 34 is formed of any suitable material such as a rubber, plastic or foam material that is both flexible and soft and durable. However any other material is hereby contemplated for use. In one arrangement, the material of neck pad 34 has a generally high coefficient of friction which helps the mobile device holder system 10 to remain in position on the user's body and prevents slippage of the mobile device holder system 10. That is, when the material of neck pad 34 has a high coefficient of friction neck pad 34 tends to grip and not slide upon the user's neck and/or shoulder area and/or clothing.

Upper Torso Section:

Upper torso section 24 is formed of any suitable size, shape and design and serves as a structural support element that is positioned on one side of the user's head opposite the keeper section 20 and which is positioned on the other side of the user's head. In the arrangement shown, as one example, upper torso section 24 begins at its upper end at hinge 18 which is positioned between the end of neck section 22 and upper torso section 24 and terminates at its lower end at a hinge 18 which is positioned between the upper torso section 24 and lower torso section 26. In one arrangement, as is shown, upper torso section 24 extends in a relatively vertical manner in a relatively straight or curved manner between these hinges 18 and contours to the shape of the user's body. In one arrangement, upper torso section 24 is relatively the same size and shape as keeper section 20 with a difference being the end of upper torso section 24 connects at its lower end to a hinge 18, instead of terminating at its lower end as does keeper section 20

In one arrangement, upper torso section 24 is formed of a rigid member. In another arrangement, upper torso section 24 is a flexible or malleable member so that the shape of upper torso section 24 may be conformed to the size and shape of the user's body. In another arrangement, upper torso section 24 includes portions that are rigid and other portions that are flexible or malleable which provides the benefits of being rigid where it is needed and flexible or malleable where adjustment may be required thereby providing the benefits of both.

Lower Torso Section:

Lower torso section 26 is formed of any suitable size, shape and design and serves as a structural support element that is positioned on one side of the user's head opposite the keeper section 20 below upper torso section 24 and which is positioned on the other side of the user's head. In the arrangement shown, as one example, lower torso section 26 begins at its upper end at hinge 18 which is positioned between the lower end of upper torso section and the upper end of lower torso section 26 and terminates at its lower end at a hinge 18 which is positioned between the lower end of lower torso section 26 and lower section 28. In one arrangement, as is shown, lower torso section 26 extends in a relatively vertical manner in a relatively straight or curved manner between these hinges 18 and contours to the shape of the user's body. In one arrangement, when in a deployed position lower torso section 26 continues in the general shape and direction as upper torso section 24 and extends downward along the user's body or torso.

In one arrangement, lower torso section 26 is formed of a rigid member. In another arrangement, lower torso section 26 is a flexible or malleable member so that the shape of lower torso section 26 may be conformed to the size and shape of the user's body. In another arrangement, lower torso section 26 includes portions that are rigid and other portions that are flexible or malleable which provides the benefits of being rigid where it is needed and flexible or malleable where adjustment may be required thereby providing the benefits of both.

When upper torso section 24 and lower torso section 26 are combined and connected to one another, upper torso section 24 and lower torso section 26 extend a desired length of the user's body between neck section 22 at the upper end of the system 10 and lower section 28 at the lower end of the system 10. In one arrangement, to provide adjustability to this length, one or both of upper torso section 24 and lower torso section 26 are adjustable lengthwise. This adjustability may come from being formed of materials that can be stretched or compressed, or to a mechanical arrangement that facilities extension and compression such as a telescoping member, extendible members or the like.

In one arrangement upper torso section 24 and lower torso section 26 are referred to collectively as simply torso section. Torso section may be formed of a continuous length of main bar 12 and may not include a hinge 18, or alternatively torso section may be separated into upper torso section 24 and lower torso section 26 by a hinge 18, or alternatively yet, torso section may be separated into more than two sections by more than one hinge 18, all of which are collectively referred to as a torso section that connects at its upper end to neck section 22 and at its lower end to lower section 28.

Lower Section:

Lower section 28 is formed of any suitable size, shape and design and serves as a structural support element and extends partially across the user's body and serves to position the mobile device 44 at approximately the center of the user's body. In the arrangement shown, as one example, lower section 28 begins at its outward end at hinge 18 which is positioned between the lower end of lower torso section 26 and the outward end of lower section 26 and terminates at its inward end at a hinge 18 which is positioned between the inward end of lower section 28 and the inward end of extension section 30. In one arrangement, as is shown, lower section 28 extends in a relatively horizontal or lateral manner in a relatively straight or curved manner between these hinges 18 and contours to the shape of the user's body. In this way, lower section 28 extends in a generally perpendicular manner across the user's body in comparison to upper torso section 24 and lower torso section 26 which extend down the user's body. As such the length of lower section 28 is generally perpendicularly aligned to the length of upper torso section 24 and lower torso section 26. In the arrangement shown, as one example, lower section 28 curves outward slightly as it extends between hinges 18 so as to conform to the curvature of a user's body. In one arrangement, when in a deployed position lower section 28 is positioned at about the mid-portion or the user's body or torso.

In one arrangement, lower section 28 is formed of a rigid member. In another arrangement, lower section 28 is a flexible or malleable member so that the shape of lower section 28 may be conformed to the size and shape of the user's body. In another arrangement, lower section 28 includes portions that are rigid and other portions that are flexible or malleable which provides the benefits of being rigid where it is needed and flexible or malleable where adjustment may be required thereby providing the benefits of both.

When in position, lower section 28 extends inward from the outwardly positioned upper torso section 24 and lower torso section 26 which extend downward along a side of the user's body or torso. In this way, lower section 28 centers mobile device 44 on the user's body. In this way, the lateral length of lower section 28 extends in approximately parallel spaced relation to the lateral length of neck section 22 and helps to enclose the loop formed by neck section 22 and upper torso section 24 and lower torso section 26.

The engagement between lower section 28 and the user's body causes the extension section 30, telescoping section 32 and the attached mobile device 44 to be forced outward and upward, lower section 28 presses into the user's body with some force. In one arrangement a chest pad 36 is placed over the lower section 28 so as to spread out the contact area between the user's body and the lower section 28 and to provide some cushion to this engagement thereby improving user comfort.

Chest Pad:

Chest pad 36 is formed of any suitable size, shape and design and serves to engage the user's torso and to spread out the contact area between the user's torso and the lower section 28 thereby improving user comfort. In the arrangement shown, chest pad 36 is generally centrally positioned upon lower section 28 and curves in accordance with the curvature lower section 28 which curves in accordance with the curvature of the user's body. In the arrangement shown, as one example, chest pad 36 extends a lateral length between opposing ends 56. In one arrangement, as is shown, chest pad 36 is generally cylindrical in shape, however any other shape is hereby contemplated for use.

Chest pad 36 is formed of any suitable material such as a rubber, plastic or foam material that is both flexible and soft and durable. However any other material is hereby contemplated for use. In one arrangement, the material of chest pad 36 has a generally high coefficient of friction which helps the mobile device holder system 10 to remain in position on the user's body and prevents slippage of the mobile device holder system 10. That is, when the material of chest pad 36 has a high coefficient of friction chest pad 36 tends to grip and not slide upon the user's neck and/or shoulder area and/or clothing. In addition, the softness and compressibility of chest pad 36 softens the force of engagement between the user's torso and the lower section 28 and makes it more comfortable to wear mobile device holder system 10 for long periods of time.

Extension Section:

Extension section 30 is formed of any suitable size, shape and design and serves as a structural support element and extends outward from the user's body and serves to position the mobile device 44 at approximately the center of the user's body and at the appropriate distance away from the user's body. In the arrangement shown, as one example, extension section 30 begins at its inward end at hinge 18 which is positioned between the inward end of extension section 30 and the outward end of lower section 26 and terminates at its outward end at second end 16 which connects to telescoping section 32. In one arrangement, as is shown, extension section 30 extends in a relatively horizontal or lateral manner in a relatively straight or curved manner between hinges 18 and end 16. In this way, extension section 30 extends in a generally perpendicular manner to the length of lower section 28 and away from the user's body. As such the length of extension section 30 is generally perpendicularly aligned to the length of lower section 28. In the arrangement shown, as one example, while the main body or main length of extension section 30 is generally straight, the end 16 of extension section 30 includes a curved section 58 transitions the generally outwardly extending section of extension section 30 to an upwardly turned alignment. It is at this upwardly turned end 16 that connects to telescoping section 32. The main body of extension section 30 extends away from the user's body whereas the curved section 58 of extension section 30 aligns the telescoping section 32 to extend upward therefrom.

In one arrangement, extension section 30 is formed of a rigid member. In another arrangement, extension section 30 is a flexible or malleable member so that the shape of extension section 30 may be conformed to the size and shape of the user's body. In another arrangement, extension section 30 includes portions that are rigid and other portions that are flexible or malleable which provides the benefits of being rigid where it is needed and flexible or malleable where adjustment may be required thereby providing the benefits of both. As one example, the main body of extension section 30 between hinge 18 and curved section 58 may be rigid whereas the curved section 58 is somewhat flexible or malleable or adjustable. This adjustability in the curved section 58 allows for angular alignment of telescoping section 32 and ultimate positioning of mobile device 44. While curved section 58 may be adjustable, curved section 58 is rigid or firm enough to maintain its position once adjusted by the user.

Telescoping Section:

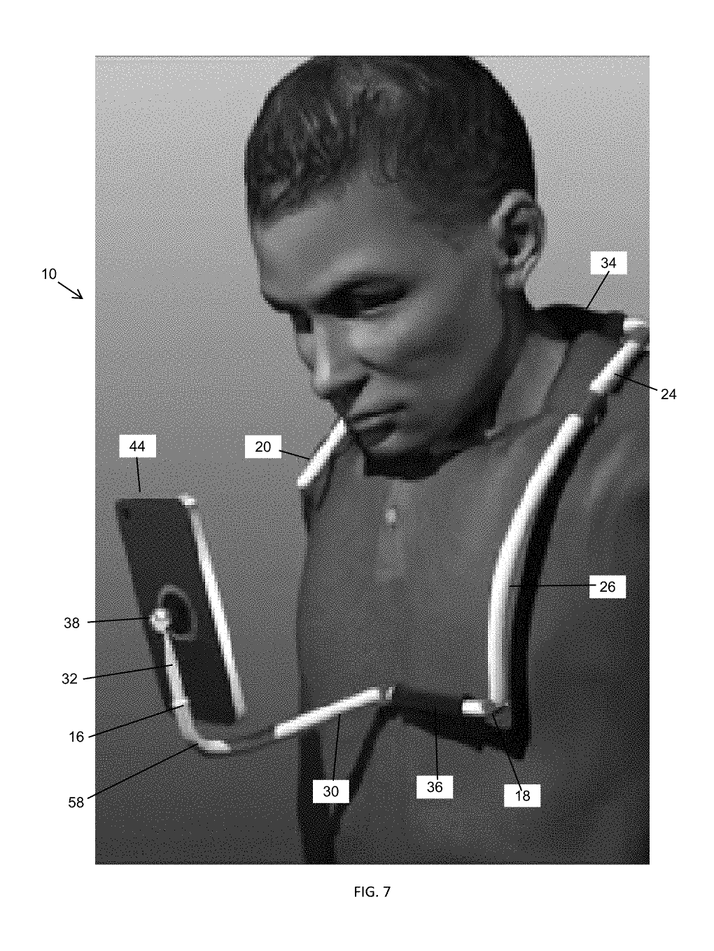

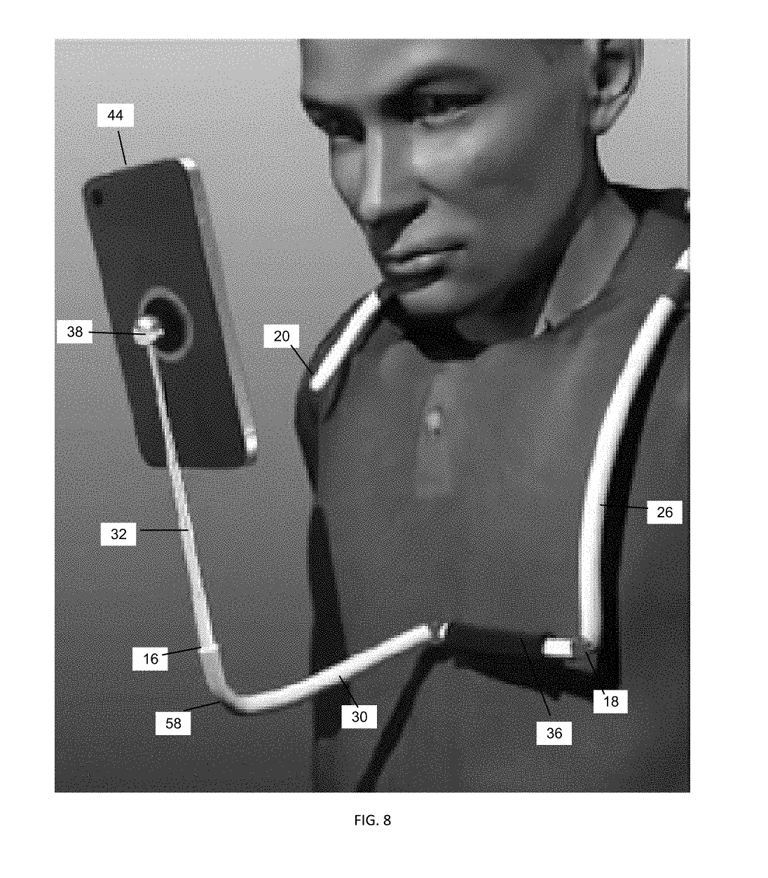

Telescoping section 32 is formed of any suitable size, shape and design and serves as a structural support element and extends outward and/or upward from extension section 30 so as to properly position the mobile device 44 in the desired position. In the arrangement shown, as one example, telescoping section 32 begins at its lower end at end 16 of extension section 30 and extends upward therefrom and terminates at its upper end at universal joint 38. In one arrangement, as is shown, telescoping section 32 extends in a relatively vertical manner in a relatively straight manner. In this way, telescoping section 32 extends in a generally upward and/or perpendicular manner to the length of extension section 30. In the arrangement shown, as one example, telescoping section 32 has a adjustable length. In one arrangement, as is shown, this is accomplished by having telescoping sections of telescoping section 32 that are in overlapping condition with one another and nest within one another allowing the telescoping section 32 to transition from a fully retracted position (as is shown in FIG. 7) and a fully extended position (as is shown in FIG. 8). Any other form of a length extending member is hereby contemplated for use in place of telescoping members. Telescoping section 32 connects at its upper end, opposite its lower end, to universal joint 38.

Telescoping section 32 allows the user to position mobile device 44 at the desired height by sliding the telescoping section 32 to the desired length. While adjustable in length, the telescoping section 32 has enough internal friction to maintain the position that it is adjusted to even when a heavy mobile device 44 is connected to the end of telescoping section 32. This vertical adjustability, coupled with the angular adjustability provided by the flexibility, malleability, and/or adjustability of extension section 30, or in one arrangement the flexibility, malleability, and/or adjustability of curved section 58, facilitates the vertical as well as lateral positioning of mobile device 44. As such, telescoping section 32 is universally and infinitely adjustable.

In one arrangement, telescoping section 32 is formed of a rigid member formed of a plurality of nesting segments which may be made of a plastic, composite or metallic material that is strong and durable. In one arrangement, these plurality of nesting segments formed of hollow cylindrical members of increasing or decreasing size, such that one segment fits within the next segment which fits within the next segment, and so on. This arrangement provides a great amount of adjustable length, while providing for a compact length when in a compressed position for easy storage.

Universal Joint:

Universal Joint 38 is formed of any suitable size, shape and design and serves to connect mobile device 44 to the mobile device holder system 10 as well as facilitate adjustment of mobile device 44. In one arrangement, as is shown, universal joint 38 includes a socket member 60 that receives a pivoting ball 62 therein. In one arrangement, the pivoting ball 62 is magnetically held within socket 60 which allows for adjustment of the position of the ball 62 within the socket 60 while also providing resistance that holds the adjusted position after adjustment.

The connection of the pivoting ball 62 to the socket 60 allows for vertical tilt adjustment. The connection of the pivoting ball 62 to the socket 60 also allows for lateral tilt adjustment. In addition, the connection of universal joint 38 to telescoping section 32 also allows for the position of universal joint 38 to spin on telescoping section 32, or said another way, universal joint 38 may rotate 360 degrees. As such, universal joint 38 is universally and infinitely adjustable.

In one arrangement, as is shown, a plate 40 is connected to ball 62. In one arrangement, plate 40 is generally planar in shape and has a circular exterior periphery, however any other shape is hereby contemplated for use. In one arrangement, plate 40 is magnetic and serves to magnetically attract plate 42 connected to mobile device 44. In another arrangement, plate 40 is metallic or non-metallic and a magnetic member is positioned within ball 62 and/or other portions of universal joint 38 such that universal joint 38 in association with plate 40 magnetically attract a plate 42 connected to mobile device 44. It is hereby contemplated that mobile device 44 and universal joint 38 may connect to one another by any other manner or method.

Universal joint 38 facilitates adjustment of the angle and position of the mobile device 44 without any tools. The user simply grasps the mobile device 44 and adjusts it to the desired angle and position. Upon the user's release of the mobile device 44 the angle and position of the mobile device 44 will remain where it was set.

Attachment of Mobile Device:

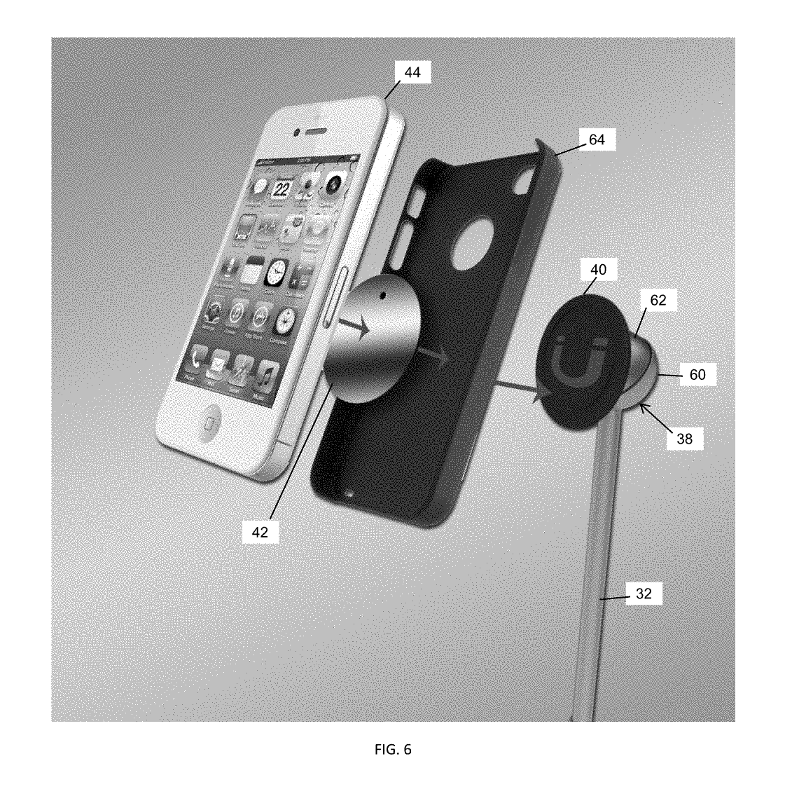

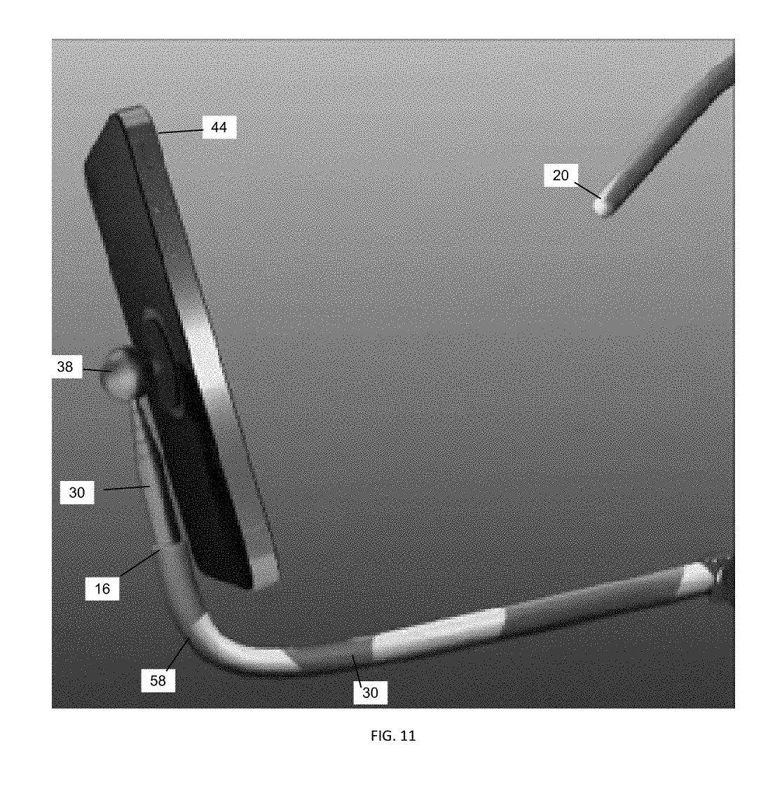

In one arrangement, a plate 42 is connected to mobile device 44. Plate 44 is formed of any suitable size, shape and design and facilitates magnetic connection of mobile device 44 to universal joint 38. In one arrangement, as is shown in FIG. 11 plate 42 is generally planar in shape and has a circular periphery, however any other shape is hereby contemplated for use and plate 44 is adhered to mobile device 44 which is then magnetically connected to universal joint 38. In another arrangement, as is shown in FIG. 6, plate 42 is positioned between mobile device 44 and a cover 64 and the plate 42 is magnetically connected to universal joint 38 through the cover 64. In one arrangement, plate 42 itself may be magnetic, which improves the magnetic connection of plate 42 to plate 40. In another arrangement, plate 42 is ferrous but not magnetic, which facilitates magnetic connection of plate 42 to plate 40. It is hereby contemplated that mobile device 44 and universal joint 38 may connect to one another by any other manner or method.

Any Number of Sections:

In the arrangement shown, as one example, main bar 12 is separated into keeper section 20, neck section 22, upper torso section 24, lower torso section 28, lower section 30 and extension section 32 by hinges 18. However any other number of sections may be contemplated for use. Including one, two, three, four, five, six, seven, eight, nine, ten or more.

Vibrations and Bouncing:

It has been tested that vibrations and bouncing of mobile device 44 is undesirable during hands-free use. In one arrangement, to cure or reduce undesirable bouncing and vibrations that distort the video, system 10 is formed of a vibration deadening material that absorbs vibrations and thereby provides a more-stable video experience. In another arrangement, to cure or reduce undesirable bouncing and vibrations that distort the video, system 10 is includes a shock absorbing member that absorbs vibrations and other girations of mobile device thereby providing a more-stable video experience.

In Use:

When mobile device holder system 10 is in use, the user places their head through the opening formed between the inward facing surfaces of keeper section 20, neck section 22 and upper torso section 24 such that the inward surface of neck pad 34 rests on the back of the user's neck or shoulder area and the rearward surfaces of keeper section 20 and upper torso section 24 rest upon the forward surface of the user's chest. When mobile device holder system 10 includes flexible or adjustable members the user bends these members to conform to their particular size and shape for maximum comfort.

In this arrangement, the lower torso section 26 extends down the user's torso below the upper torso section 24 and the lower section 28 extends inward across the user's torso with the chest pad 36 engaging the user's torso. Extension section 30 extends outward from the user's body and away from the inward end of lower section 28. The telescoping section 32 extends upward from the outward end 16 of extension section 30.

The user adjusts the angle that the telescoping section 32 extends by adjusting the curvature of curved section 58 of extension section 30, or by adjusting any other portion of extension section 30 or the mobile device holder system 10 in general. The user also adjusts the length of the telescoping section 32 by extending and/or compressing the overlapping segments of the telescoping section 32 until the desired height and positon is accomplished.

The user installs mobile device with plate 42 thereon onto the plate 40 of universal joint 38 such that the universal joint 38 and the mobile device 44 are magnetically held to one another. Once the universal joint 38 and the mobile device 44 are connected, the angle, position and orientation of the mobile device 44 is adjusted by rotating and/or tilting mobile device 44 on universal joint 38 which causes the ball 62 to spin or rotate within socket 60.

Once the mobile device 44 is in the desired position, the friction and/or resilience of the adjustable components of the system 10 maintain the adjusted positon of the system 10 and mobile device 44. The mobile device 44 can then be used for live streaming, video calling or any other purpose in a hands free manner. The relative position of the mobile device holder system 10 is maintained on the user's body by the friction between the user's body and/or clothing and the neck pad 34 and/or chest pad 36 which have a high coefficient of friction which resists slipping or movement.

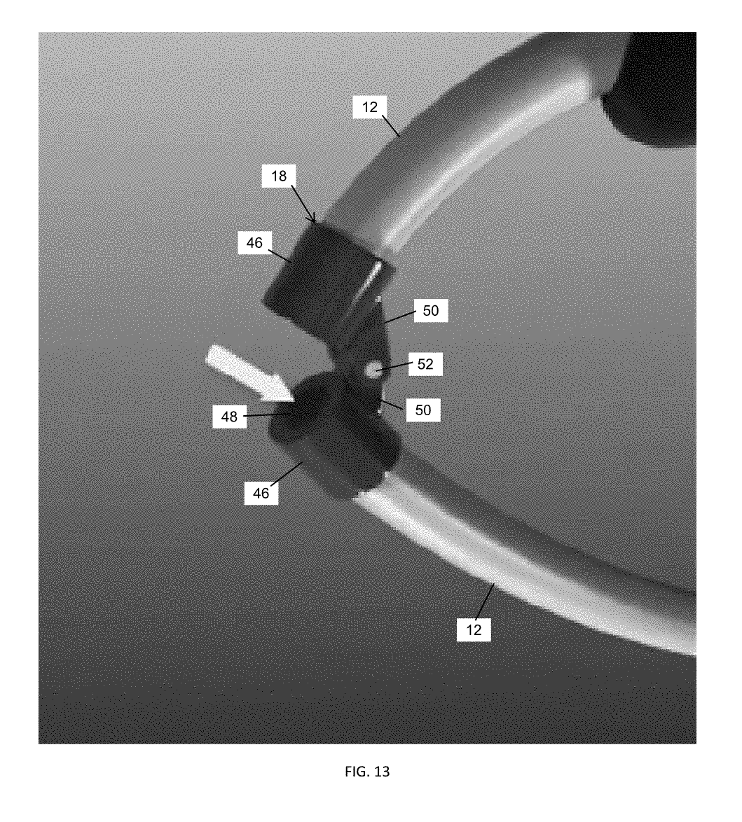

When the user is done using the mobile device holder system 10 the user simply pulls the mobile device 44 off of the universal joint 38 applying sufficient force to break the magnetic connection between universal joint 38 and plate 42. Next, the user collapses the telescoping section 32 to a fully collapsed section. Next the user folds each of the hinges 18, such as is shown in FIG. 13.

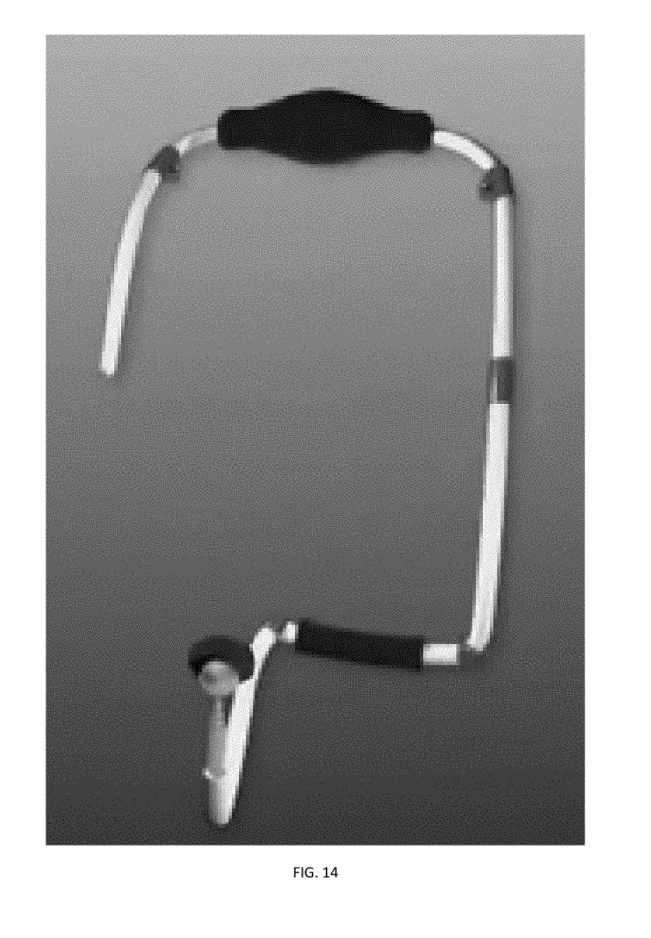

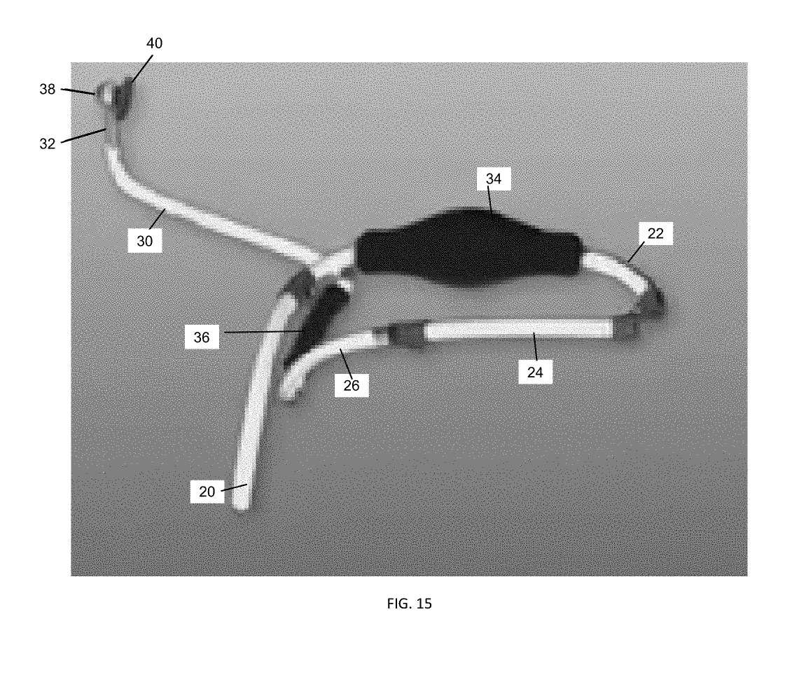

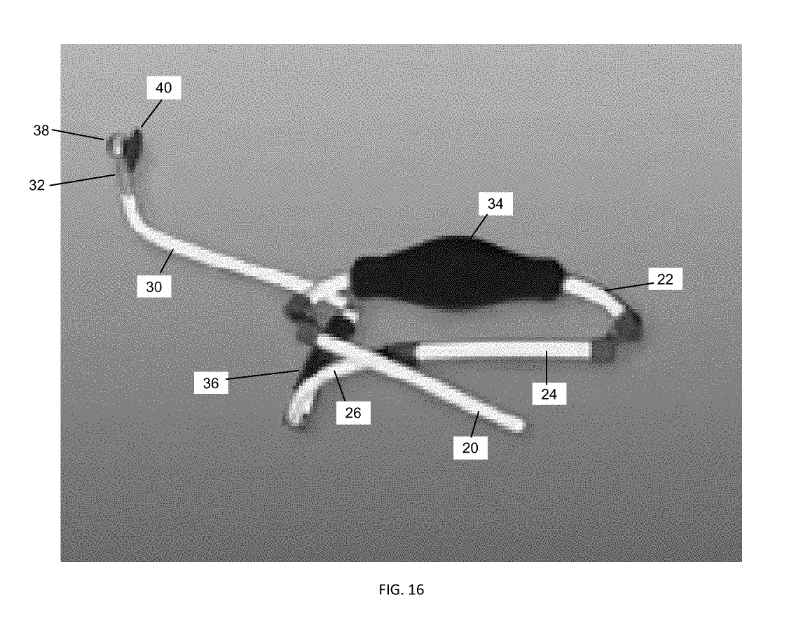

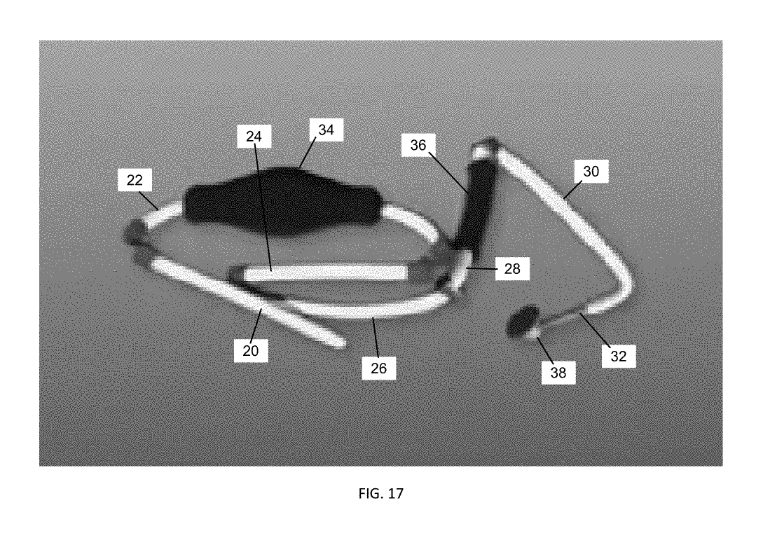

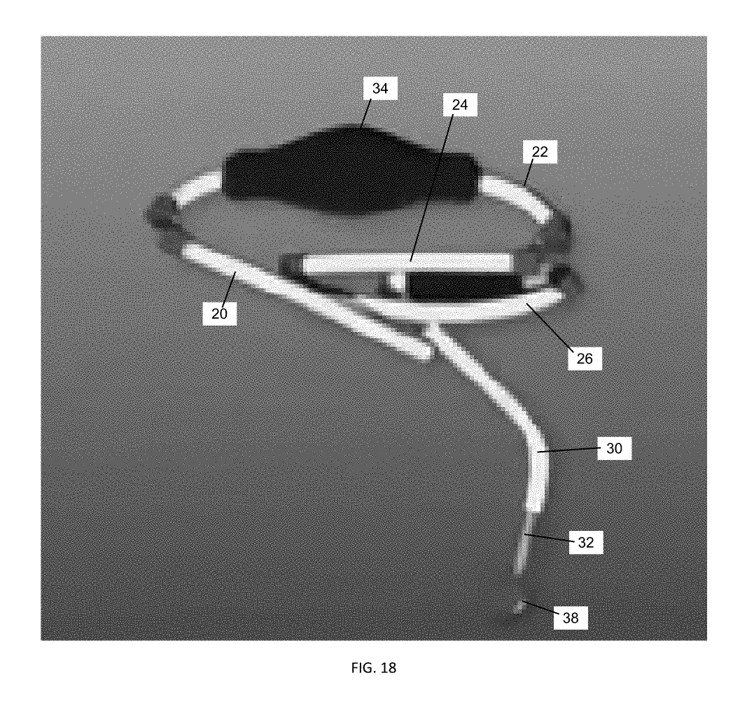

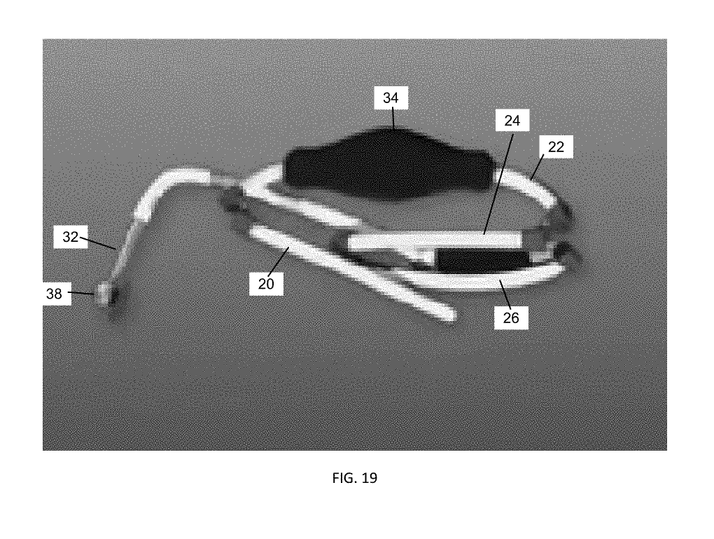

More specifically, as one example, as is shown in FIG. 14 the mobile device holder system 10 is in a fully deployed position. To move the mobile device holder system 10 to a folded position the user folds the hinge 18 between neck section 22 and upper torso section 24, as is shown in FIG. 15. Next, to move the mobile device holder system 10 to a folded position the user folds the hinge 18 between neck section 22 and keeper section 20, as is shown in FIG. 16. Next, to move the mobile device holder system 10 to a folded position the user folds the hinge 18 between upper torso section 26 and the lower torso section 26, as is shown in FIG. 17. Next, to move the mobile device holder system 10 to a folded position the user folds the hinge 18 between lower torso section 26 and the lower section 28, as is shown in FIG. 18. Next, to move the mobile device holder system 10 to a folded position the user folds the hinge 18 between the lower section 28 and the extension section 30, as is shown in FIG. 19, which represents the fully folded or fully compressed position of mobile device holder system 10.

The mobile device holder system 10 is extended to a fully deployed position in the opposite manner described herein.

As such all of the stated and unstated objectives of the mobile device holder system 10 are hereby met. The exact specifications, materials used, and method of use of the phone holder system may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

What is claimed:

1. A mobile device holder system, comprising:
a main bar;
the main bar extending a length from a first end to a second end;
the main bar having a plurality of sections that are separated by hinges;
wherein the plurality of hinges facilitate movement of the plurality of sections between a deployed position and a folded position;
a telescoping section;
wherein the telescoping section has an adjustable length;
a first end of the telescoping section end connected to the second end of the main bar;
a second end of the telescoping section connected to a universal joint;
a mobile device connected to the universal joint;
wherein when the main bar is placed around a head of a user the telescoping section holds the mobile device in front of the user's body thereby facilitating hands-free use of the mobile device.

2. The system of claim 1, wherein the main bar includes a keeper section, a neck section, a torso section, a lower section and an extension section separated by hinges that facilitate folding adjacent sections.

3. The system of claim 1, further comprising a neck pad connected to the main bar, wherein the neck pad is configured to engage a neck or shoulder area of the user.

4. The system of claim 1, further comprising a chest pad connected to the main bar, wherein the chest pad is configured to engage a torso of the user so as to facilitate positioning the mobile device in front of the user's body.

5. The system of claim 1, wherein the universal joint includes a socket which receives a ball therein that facilitates angular adjustment of the mobile device.

6. The system of claim 1, wherein the universal joint includes a socket which receives a ball and includes a magnetic member that magnetically attracts a plate connected to the mobile device.

7. The system of claim 1, wherein the universal joint includes a magnetic member that facilitates magnetic connection to the mobile device.

8. The system of claim 1, wherein the universal joint facilitates lateral tilting of the mobile device.

9. The system of claim 1, wherein the universal joint facilitates vertical tilting of the mobile device.

10. The system of claim 1, wherein the plurality of hinges include a magnetic member that operates to hold the hinges in a deployed state.

11. A mobile device holder system, comprising:
a main bar;
the main bar extending a length from a first end to a second end;
the main bar forming an opening through which a user's head is received;
the main bar having a neck section that is configured to be placed behind the user's neck;
the main bar having an extension section that extends away from the user's body;
a telescoping section connected to the second end of the main bar;
wherein the telescoping section has an adjustable length;
a universal joint connected to an upward end of the telescoping section;
a mobile device connected to the universal joint;
wherein when the main bar is placed around a head of a user the telescoping section holds the mobile device in front of the user's body thereby facilitating hands-free use of the mobile device.

12. The system of claim 11, wherein the main bar includes a keeper section, a neck section, a torso section, a lower section and an extension section separated by hinges that facilitate folding adjacent sections.

13. The system of claim 11, further comprising a neck pad connected to the neck section, wherein the neck pad is configured to engage a neck or shoulder area of the user.

14. The system of claim 11, further comprising a chest pad connected to the main bar, wherein the chest pad is configured to engage a torso of the user so as to facilitate positioning the mobile device in front of the user's body.

15. The system of claim 11, wherein the universal joint includes a socket which receives a ball therein that facilitates angular adjustment of the mobile device.

16. The system of claim 11, wherein the universal joint includes a socket which receives a ball and includes a magnetic member that magnetically attracts a plate connected to the mobile device.

17. The system of claim 11, wherein the universal joint includes a magnetic member that facilitates magnetic connection to the mobile device.

18. The system of claim 11, wherein the universal joint facilitates lateral tilting and vertical tilting of the mobile device.

19. The system of claim 11, wherein the plurality of hinges include a magnetic member that operates to hold the hinges in a deployed state.

20. A mobile device holder system, comprising:
a main bar;
the main bar extending a length from a first end to a second end;
wherein the main bar includes a keeper section, a neck section, a torso section, a lower section and an extension section separated by hinges that facilitate folding adjacent sections;
the main bar forming an opening through which a user's head is received;
a telescoping section connected an outward end of the extension section;
wherein the telescoping section has an adjustable length;
a universal joint connected to an upward end of the telescoping section;
a mobile device connected to the universal joint;
wherein when the main bar is placed around a head of a user the telescoping section holds the mobile device in front of the user's body thereby facilitating hands-free use of the mobile device.
